(19) United States
(12) Patent Application Publication
(10) Pub. No.: US 2023/0195609 A1
(43) Pub. Date: Jun. 22, 2023

(54) AUTOMATIC GENERATION OF SUMMARY REPORT FOR VALIDATION TESTS OF COMPUTING SYSTEMS

(71) Applicant: HEWLETT PACKARD ENTERPRISE DEVELOPMENT LP, Houston, TX (US)

(72) Inventors: Gary C. Wall, Allen, TX (US); Vijayanand Maram, Santa Clara, CA (US)

(21) Appl. No.: 17/645,230

(22) Filed: Dec. 20, 2021

(51) Int. Cl. G06F 11/36; G06F 11/30

(52) U.S. Cl. CPC G06F 11/3688; G06F 11/3684; G06F 11/3692; G06F 11/3072

(57) ABSTRACT

Example implementations relate to validation testing of computing systems. An example includes a computing device including a controller, a memory, and a storage storing instructions executable to: receive a plurality of validation test updates from a plurality of test systems, where each validation test update comprises test data and a line item label, and where the test data indicates a progress level of a validation test of a computing system; generate a plurality of validation test records in a database based on the received plurality of validation test updates; determine a set of line item labels to be included in a test summary report; identify a set of validation test records in the database that match the determined set of line item labels; and generate the test summary report based on the identified set of validation test records that match the set of line item labels.

### BACKGROUND

Computing devices and software are widely used in modern society. For example, most individuals use and interact with computing systems such as desktop computers, laptops, smartphones, and so forth. Such computing devices may host and execute software applications. Applications are becoming increasingly complex and may include millions of lines of code. Such applications and computing devices may be tested to ensure proper functionality and reliability.

### BRIEF DESCRIPTION OF THE DRAWINGS

Some implementations are described with respect to the following figures.

FIG. 1 is a schematic diagram of an example system, in accordance with some implementations.

FIG. 2 is an illustration of an example process, in accordance with some implementations.

FIG. 3 is an illustration of an example process, in accordance with some implementations.

FIG. 4A is an illustration of an example process, in accordance with some implementations.

FIG. 4B is a schematic diagram of an example system, in accordance with some implementations.

FIG. 5A is an illustration of an example process, in accordance with some implementations.

FIG. 5B is an illustration of an example test summary report, in accordance with some implementations.

FIG. 6 is an illustration of an example process, in accordance with some implementations.

FIG. 7 is a diagram of an example machine-readable medium storing instructions in accordance with some implementations.

FIG. 8 is a schematic diagram of an example computing device, in accordance with some implementations.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

In the present disclosure, use of the term “a,” “an,” or “the” is intended to include the plural forms as well, unless the context clearly indicates otherwise. Also, the term “includes,” “including,” “comprises,” “comprising,” “have,” or “having” when used in this disclosure specifies the presence of the stated elements, but do not preclude the presence or addition of other elements.

In some examples, computing devices and software may undergo testing during development or update processes. For example, before a software application is released for public use, it may undergo validation testing by executing the application on multiple computing platforms. Further, such testing may include repeated rounds of testing that may vary in test type, test duration, network connection type, and so forth. In some examples, such testing may be performed using different automated testing tools that may test different features or aspects of the application under test. The test results may be used to find faults in the application, to improve performance of the application, and so forth.

As computer and software systems have increased in size and complexity over time, there has been a need for performing more numbers and types of validation tests for those systems. Further, such increased levels of testing have involved the use of a larger variety of testing tools and systems. However, these changes have made it more difficult to track and manage the progress of the testing. For example, to determine the status of the testing, a manager may have to interact with multiple testing tools to analyze a relatively large number and variety of test results. Alternatively, the manager may be provided with a report that attempts to consolidate the aforementioned testing information into a form that is easy to obtain and understand. However, this approach may involve custom programming to interface with multiple different testing systems that may have different data formats, test structures, user interfaces, access limitations, and so forth. Accordingly, the complexity of obtaining and analyzing the testing data may make it difficult to determine the status of the testing quickly and easily.

In accordance with some implementations of the present disclosure, a test report device (e.g., a computer device) may automatically generate a report that summarizes the progress of multiple types of validation tests (referred to herein as a “test summary report”), thereby allowing users to determine the status of the validation tests quickly and easily. In some implementations, a report definition may include a set of line item labels. Each line item label may be an alphanumeric string that is defined to identify a particular grouping of validation tests, and may represent any desired level of abstraction of the tests. For example, a single line item label (e.g., “upgrade)tests”) may represent different sets of tests that are performed in parallel during a system upgrade involving multiple hardware and software components. A set of computing systems that conduct the validation tests (referred to herein as “testing systems”) may send updates including test progress data and the appropriate line item label to the test report device via a push interface. The test report device may store the received test updates in a database for later use in generating test reports. Further, the stored test updates may be appended with annotations that may provide additional information or analysis of the test results.

In some implementations, when generating a test summary report, the test report device may identify a set of test update records that include the line item labels specified in the report definition. The test report device may then generate the test summary report using the identified test update records and their associated annotations. In some implementations, the test progress data and annotations associated with each line item label may be presented as a separate line item (e.g., row or section) in the test summary report. In this manner, the disclosed technique may provide a test summary report that presents progress information for multiple tests and system in a consolidated form that is easy to understand. Further, the test summary report may be generated with a relatively simple setup process, and therefore may not require extensive custom system design and programming to interface with multiple different testing systems.

Accordingly, some implementations described herein may provide improved reporting and management of validation testing of computer systems.

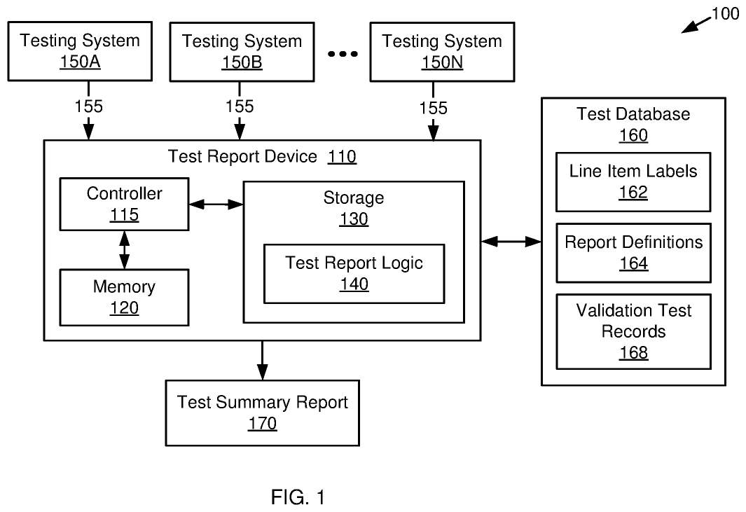

FIG. 1—Example Storage System

FIG. 1 shows an example system 100 that includes a test report device 110, a test database 160, and any number of testing devices 150A-150N (also referred to herein as “testing device 150”). In some implementations, the test report device 110 may be hardware computing device that include a controller 115, memory 120, and storage 130. The storage 130 may include one or more non-transitory storage media such as hard disk drives (HDDs), solid state drives (SSDs), optical disks, and so forth, or a combination thereof. The memory 120 may be implemented in semiconductor memory such as random-access memory (RAM). In some examples, the controller 115 may be implemented via hardware (e.g., electronic circuitry) or a combination of hardware and programming (e.g., comprising at least one processor and instructions executable by the at least one processor and stored on at least one machine-readable storage medium).

In some implementations, the storage 130 may include test report logic 140. In some examples, the test report logic 140 may be implemented in executable instructions stored in the storage 130 (e.g., software and/or firmware). However, the test report logic 140 can be implemented in any suitable manner. For example, some or all of the test report logic 140 could be hard-coded as circuitry included in the controller 115. In other examples, some or all of the test report logic 140 could be implemented on a remote computer (not shown), as web services, and so forth.

In some implementations, the testing systems 150A-150N may include any number and type of testing devices and tools. For example, the testing systems 150A-150N may include different test software applications that perform different types of validation tests, have different data structures and formats, have different data and user interfaces, and so forth. Each of the testing systems 150A-150N may be configured to send validation test updates 155 to the test report device 110 (e.g., in response to a command or signal, based a periodic schedule or timer, etc.). Each validation test update 155 may include information regarding the validation testing being performed by the testing system 150 that sent the validation test update 155. In some implementations, the testing system 150 may send the validation test update 155 to the test report device 110 via a push interface (e.g., a representational state transfer application programming interface (REST API)). Further, in some implementations, the validation test updates 155 may include partial test results (e.g., progress data for a test that has not been completed) or complete test results.

In some implementations, the test report device 110 may receive a new line item label 162 for use in generating one or more test summary reports 170. The test report device 110 may store the new line item label 162 and a description in a record of the test database 160. Each line item label 162 may be an alphanumeric string that is defined to identify a particular grouping of validation tests. For example, the line item label “12 hr test” may be specified by a user to identify all validation tests with a duration of twelve hours. In another example, the line item label “backup test” may be specified to identify all validation tests of system backup functionality. In some implementations, the line item label 162 may be a free-form or unstructured text string.

In some implementations, when a new line item label 162 is specified, the testing systems 150A-150N may be configured to determine whether a validation test is associated with the line item label 162, and if so to include (e.g., attach or embed) the line item label 162 in the validation test update 155 that is sent to the test report device 110. The test report device 110 may receive the validation test updates 155 from the testing systems 150, and may create a new validation test record 168 to store the information included in the validation test updates 155. In some implementations, the testing systems 150A-150N may be configured to include a system under test (SUT) identifier in the validation test update 155. The SUT identifier may identify a type or class of computing system that is undergoing the validation test. For example, the SUT identifier may be a build number for a software program, a model number for a server, a version number for a web application, and so forth

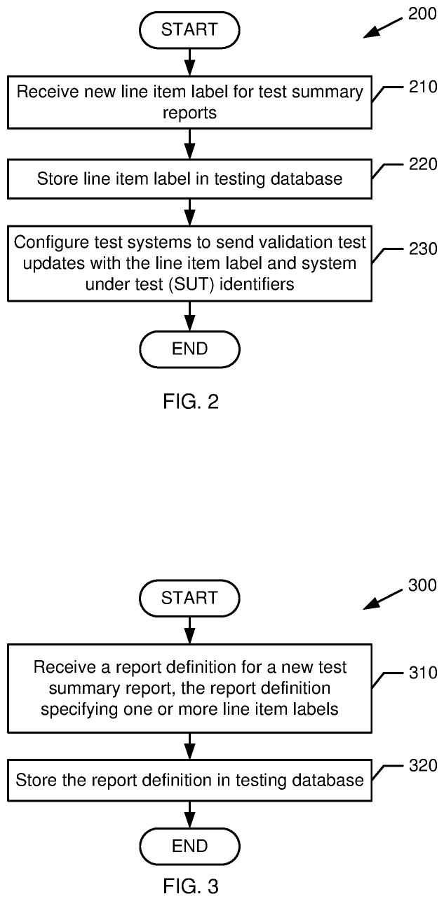

In some implementations, the test report device 110 may generate a test summary report 170 based on a report definition 164. The report definition 164 may include a set of line item labels 162. The test report device 110 may aggregate the validation test records 168 that include the line item labels 162 specified in the report definition 164. The test report device 110 may then generate the test summary report 170 using the validation test records 168. In some implementations, the test progress data associated with each line item label 162 may be presented as a separate line item (e.g., row or section) in the test summary report 170. In this manner, the test report device 110 may provide a test summary report 170 that presents progress information for multiple tests and system in a simple consolidated form. The functionality of the test report device 110 is discussed further below with reference to FIGS. 2-8.

FIG. 2—Example Process for Storing a Line Item Label

Referring now to FIG. 2, shown is an example process 200 for storing a line item label, in accordance with some implementations. The process 200 may be performed by the test report device 110 (e.g., by controller 115 executing instructions of the test report logic 140). The process 200 may be implemented in hardware or a combination of hardware and programming (e.g., machine-readable instructions executable by a processor(s)). The machine-readable instructions may be stored in a non-transitory computer readable medium, such as an optical, semiconductor, or magnetic storage device. The machine-readable instructions may be executed by a single processor, multiple processors, a single processing engine, multiple processing engines, and so forth.

Block 210 may include receiving a new line item label for use in test summary reports. Block 220 may include storing the new line item label in the testing database. Block 230 may include configuring one or more test systems to send validation test updates with the line item label(s) and system under test (SUT) identifiers. After block 230, the method 200 may be completed.

For example, referring to FIG. 1, the test report device 110 may receive an input or command (e.g., via a user interface, a web interface, etc.) specifying a line item label 162 to be available for generating one or more test summary reports 170. The test report device 110 may store the line item label 162 in the test database 160. Further, in some implementations, the testing systems 150A-150N may be configured to determine whether a validation test summary is associated with the line item label 162, and if so to include (e.g., attach or embed) the line item label 162 in the validation test summary that is sent to the test report device 110 (e.g., via a push interface). Further, the validation test update 155 may also include test data indicating the progress of the validation test being performed, and a system under test (SUT) identifier identifying the system undergoing the validation test.

FIG. 3—Example Process for Storing a Report Definition

Referring now to FIG. 3, shown is an example process 300 for storing a report definition, in accordance with some implementations. The process 300 may be performed by the test report device 110 (e.g., by controller 115 executing instructions of the test report logic 140). The process 300 may be implemented in hardware or a combination of hardware and programming (e.g., machine-readable instructions executable by a processor(s)). The machine-readable instructions may be stored in a non-transitory computer readable medium, such as an optical, semiconductor, or magnetic storage device. The machine-readable instructions may be executed by a single processor, multiple processors, a single processing engine, multiple processing engines, and so forth.

Block 310 may include receiving a report definition for a new test summary report, where the report definition specifies one or more line item labels. Block 320 may include storing the report definition in the testing database. After block 320, the method 300 may be completed.

For example, referring to FIG. 1, the test report device 110 may receive an input or command (e.g., via a user interface, a web interface, etc.) specifying a report definition 164. In some implementations, the report definition 164 may specify a set of line item labels 162 to be used for generating a test summary report 170. Further, the report definition 164 may specify other information to be included in the test summary report 170, such as a system under test (SUT) identifier, test progress fields (e.g., percent complete, start time), and so forth. Additionally, the report definition 164 may specify a format and/or arrangement of the test summary report 170. In some implementations, the test report device 110 may store the report definition 164 in the testing database 160.

In some implementations, the report definition 164 may specify that each line item (e.g., row or section) in the test summary report 170 is to include the information associated with a particular line item label 162. Further, in other implementations, the report definition 164 may specify that each line item in the test summary report 170 is to include the information associated with a particular combination of one line item label 162 and one SUT identifier.

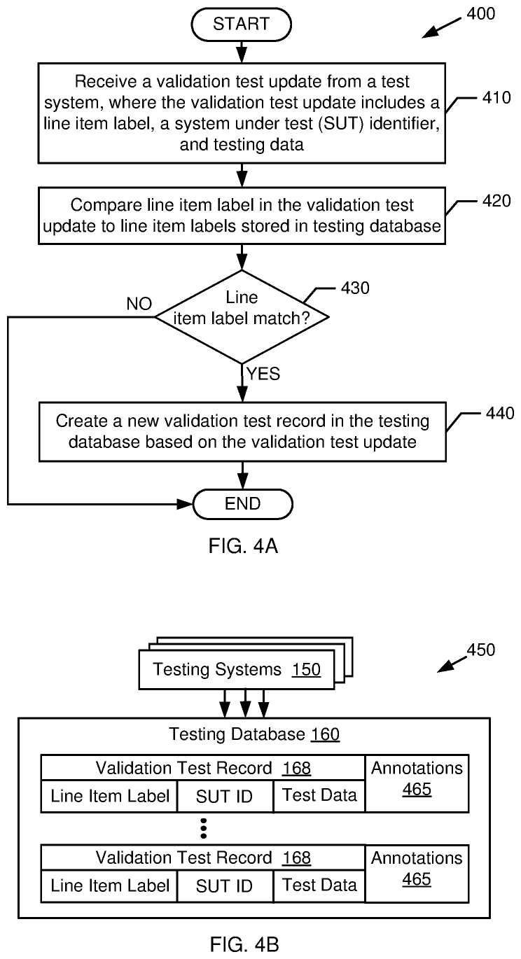

FIGS. 4A-4B—Example Process for Creating a Validation Test Record

Referring now to FIG. 4A, shown is an example process 400 for creating a validation test record, in accordance with some implementations. The process 400 may be performed by the test report device 110 (e.g., by controller 115 executing instructions of the test report logic 140). The process 400 may be implemented in hardware or a combination of hardware and programming (e.g., machine-readable instructions executable by a processor(s)). The machine-readable instructions may be stored in a non-transitory computer readable medium, such as an optical, semiconductor, or magnetic storage device. The machine-readable instructions may be executed by a single processor, multiple processors, a single processing engine, multiple processing engines, and so forth. For the sake of illustration, details of the process 400 are described below with reference to FIG. 4B, which shows an example system 450 in accordance with some implementations. However, other implementations are also possible. The system 450 may correspond generally to a portion of the system 100 (shown in FIG. 1).

Block 410 may include receiving a validation test update from a test system, where the validation test update includes a line item label, a system under test (SUT) identifier, and testing data. Block 420 may include comparing the line item label in the validation test update to the line item labels stored in testing database. Decision block 430 may include determining whether the line item label in the validation test update matches any of the line item labels stored in the testing database. If it is determined at block 430 that the line item label in the validation test update does not match any line item label stored in testing database (“NO”), then the process 400 may be completed. However, if it is determined at block 430 that the line item label in the validation test update matches a line item label stored in testing database (“YES”), then the process 400 may continue at block 440, including creating a new validation test record in the testing database based on the validation test update. After block 440, the process 400 may be completed.

For example, referring to FIGS. 1 and 4B, the test report device 110 may receive a validation test update 155 from the testing systems 150, and may read the line item label 162 included in the received validation test update 155. The test report device 110 may determine whether the line item label 162 in the validation test update 155 matches any of the line item labels 162 stored in the testing database 160 (e.g., as discussed above with reference to block 220 shown in FIG. 2). If there is a match, the test report device 110 may create a new validation test record 168 to store the information included in the validation test update 155. For example, as shown in FIG. 4B, the validation test record 168 may include the line item label, the SUT identifier, and test data from the validation test update 155. Otherwise, if there is not match, test report device 110 may drop the validation test update 155, and optionally may generate an error event or message.

In some implementations, the test report device 110 may receive an annotation 465 associated with a validation test update 155 or a line item label 162, and may store the annotation 465 in the database 160. For example, a user may interact with a web interface or a graphical user interface to provide additional information regarding the validation testing (e.g., test triage, failure information, defect identifiers, etc.). In such cases, the test report device 110 may determine that the annotation 465 is associated with the validation test update 155, and may then append the annotation 465 to the corresponding validation test record 168 in the database 160.

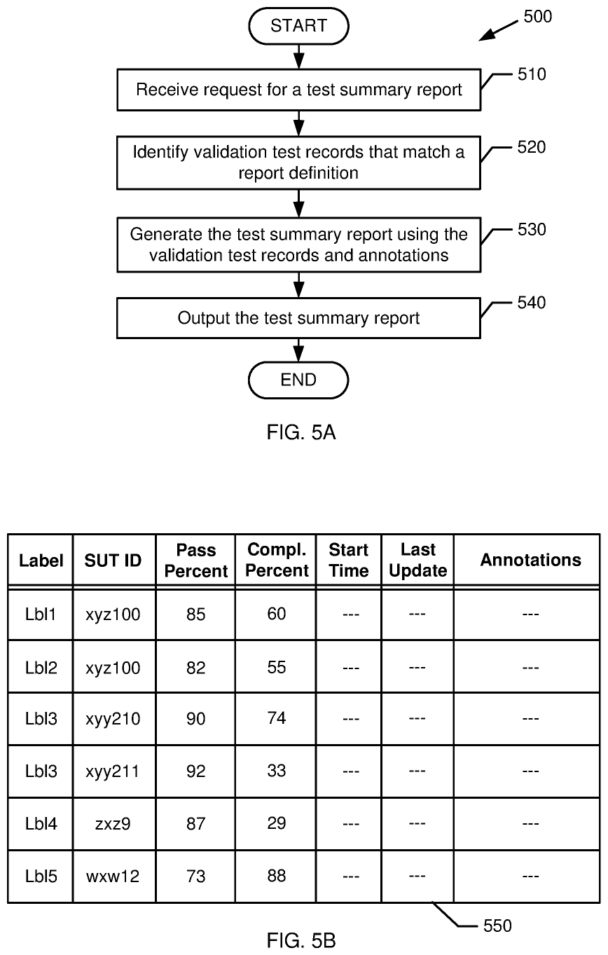

FIGS. 5A-5B—Example Process for Generating a Test Summary Report

Referring now to FIG. 5A, shown is an example process 500 for generating a test summary report, in accordance with some implementations. The process 500 may be performed by the test report device 110 (e.g., by controller 115 executing instructions of the test report logic 140). The process 500 may be implemented in hardware or a combination of hardware and programming (e.g., machine-readable instructions executable by a processor(s)). The machine-readable instructions may be stored in a non-transitory computer readable medium, such as an optical, semiconductor, or magnetic storage device. The machine-readable instructions may be executed by a single processor, multiple processors, a single processing engine, multiple processing engines, and so forth. For the sake of illustration, details of the process 500 are described below with reference to FIG. 5B, which shows an example test summary report 550 in accordance with some implementations. However, other implementations are also possible.

Block 510 may include receiving a request for a test summary report. Block 520 may include identifying one or more validation test records that match a report definition. Block 530 may include generating the test summary report using the validation test records and annotations. Block 540 may include outputting the test summary report. After block 540, the process 500 may be completed.

For example, referring to FIGS. 1 and 5B, the test report device 110 may receive a command or request (e.g., via a user interface, a web interface, etc.) to generate a test summary report 550. In response, the test report device 110 may access the report definition 164 for the requested test summary report 550, and may then read the line item labels 162 specified in the report definition 164. The test report device 110 may then aggregate the validation test records 168 (e.g., from database 160) that include the line item labels 162 specified in the report definition 164. Further, the test report device 110 may generate the test summary report 550 using information in the validation test records 168, including the line item labels, the SUT identifiers, test data, and so forth.

In some implementations, each line item (e.g., row or section) in the test summary report 550 may represent the information associated with a particular line item label 162. Further, in other implementations, each line item in the test summary report 550 may represent the information associated with a particular combination of one line item label 162 and one SUT identifier. For example, as shown in FIG. 5B, the test summary report 550 includes one line item for the combination of label “Lbl3” and SUT identifier “xyy210,” and includes another line item for the combination of label “Lbl3” and SUT identifier “xyy211.” Note that, while FIG. 5B illustrates an example in which each line corresponds to a combination of two parameters (i.e., label and SUD identifier), implementations are not limited in this regard. For example, it is contemplated that the line items of the test summary report 550 may correspond to combinations of any number of parameters (e.g., three parameters, four parameters, etc.).

In some implementations, each line item in the test summary report 550 may include one or more data elements that indicate the status and/or progress of a corresponding validation test. For example, as shown in FIG. 5B, each line item may include a test pass percentage, a test completed percentage, a test start time, a last update time, and so forth. Further, each line item may include an annotation field, which may be populated from the annotations 465 included in the corresponding validation test record 168 (shown in FIG. 4B).

In some implementations, the status or progress data included in the test summary report 550 may be derived using the most recent validation test record 168 for each line item label 162. Further, in other implementations, the status or progress data included in the test summary report 550 may be derived by combining multiple validation test records 168 for each line item label 162 (e.g., by adding multiple progress values, by averaging multiple progress values, and so forth).

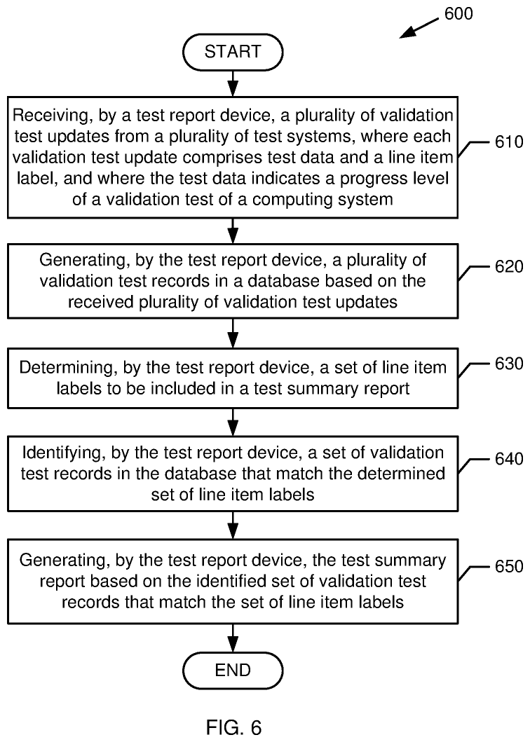

FIG. 6—Example Process for Generating a Test Summary Report

Referring now to FIG. 6, shown is an example process 600 for generating a test summary report, in accordance with some implementations. The process 600 may be performed by the test report device 110 (e.g., by controller 115 executing instructions of the test report logic 140). The process 600 may be implemented in hardware or a combination of hardware and programming (e.g., machine-readable instructions executable by a processor(s)). The machine-readable instructions may be stored in a non-transitory computer readable medium, such as an optical, semiconductor, or magnetic storage device. The machine-readable instructions may be executed by a single processor, multiple processors, a single processing engine, multiple processing engines, and so forth.

Block 610 may include receiving, by a test report device, a plurality of validation test updates from a plurality of test systems, where each validation test update comprises test data and a line item label, and where the test data indicates a progress level of a validation test of a computing system. Block 620 may include generating, by the test report device, a plurality of validation test records in a database based on the received plurality of validation test updates. For example, referring to FIG. 1, the test report device 110 may receive a validation test update 155 from the testing systems 150, and may determine whether the line item label 162 included in the received validation test update 155 was previously registered (e.g., stored in the testing database 160). If so, the test report device 110 may create a new validation test record 168 to store the information included in the validation test update 155.

Block 630 may include determining, by the test report device, a set of line item labels to be included in a test summary report. Block 640 may include identifying, by the test report device, a set of validation test records in the database that match the determined set of line item labels. Block 650 may include generating, by the test report device, the test summary report based on the identified set of validation test records that match the set of line item labels. After block 650, the process 600 may be completed. For example, referring to FIGS. 1 and 5B, the test report device 110 may receive a request to generate the test summary report 550, may access the corresponding report definition 164, and may read the line item labels 162 specified in the report definition 164. The test report device 110 may then aggregate the validation test records 168 that include the line item labels 162 specified in the report definition 164, and may generate the test summary report 550 using information in the validation test records 168 (e.g., the line item labels, the SUT identifiers, test data, and so forth).

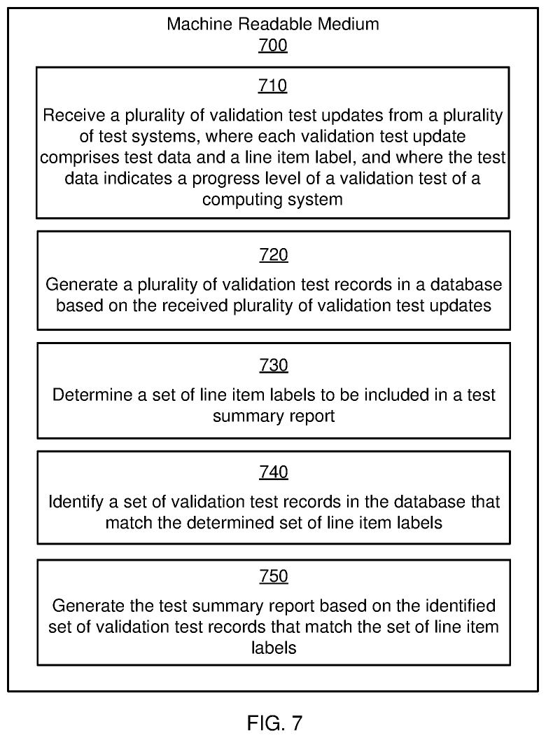

FIG. 7—Example Machine-Readable Medium

FIG. 7 shows a machine-readable medium 700 storing instructions 710-750, in accordance with some implementations. The instructions 710-750 can be executed by a single processor, multiple processors, a single processing engine, multiple processing engines, and so forth. The machine-readable medium 700 may be a non-transitory storage medium, such as an optical, semiconductor, or magnetic storage medium.

Instruction 710 may be executed to receive a plurality of validation test updates from a plurality of test systems, where each validation test update comprises test data and a line item label, and where the test data indicates a progress level of a validation test of a computing system. Instruction 720 may be executed to generate a plurality of validation test records in a database based on the received plurality of validation test updates. Instruction 730 may be executed to determine a set of line item labels to be included in a test summary report. Instruction 740 may be executed to identify a set of validation test records in the database that match the determined set of line item labels. Instruction 750 may be executed to generate the test summary report based on the identified set of validation test records that match the set of line item labels.

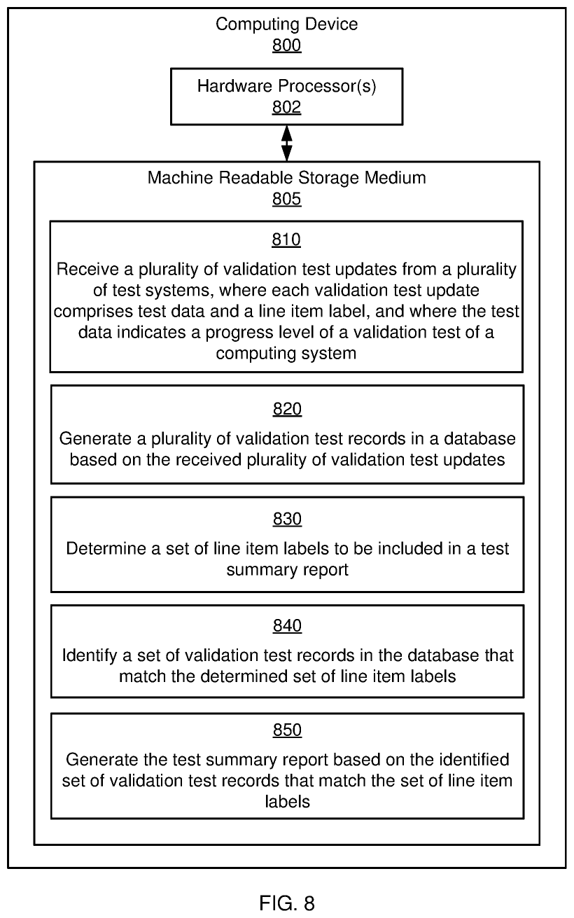

FIG. 8—Example Computing Device

FIG. 8 shows a schematic diagram of an example computing device 800. In some examples, the computing device 800 may correspond generally to some or all of the test report device 110 (shown in FIG. 1). As shown, the computing device 800 may include a hardware processor 802 and a machine-readable storage 805 including instructions 810-850. The machine-readable storage 805 may be a non-transitory medium. The instructions 810-850 may be executed by the hardware processor 802, or by a processing engine included in hardware processor 802.

Instruction 810 may be executed to receive a plurality of validation test updates from a plurality of test systems, where each validation test update comprises test data and a line item label, and where the test data indicates a progress level of a validation test of a computing system. Instruction 820 may be executed to generate a plurality of validation test records in a database based on the received plurality of validation test updates. Instruction 830 may be executed to determine a set of line item labels to be included in a test summary report. Instruction 840 may be executed to identify a set of validation test records in the database that match the determined set of line item labels. Instruction 850 may be executed to generate the test summary report based on the identified set of validation test records that match the set of line item labels.

In accordance with implementations described herein, a test report device may automatically generate a report that summarizes the progress of multiple types of validation tests, thereby allowing users to determine the status of the validation tests quickly and easily. In some implementations, the test report device may identify a set of test update records that include the line item labels specified in a report definition. The test report device may then generate the test summary report using the identified test update records and their associated annotations. In some implementations, the test progress data and annotations associated with each line item label may be presented as a separate line item in the test summary report. In this manner, the disclosed technique may provide a test summary report that presents progress information for multiple tests and system in a consolidated form that is easy to understand. Further, the test summary report may be generated with a relatively simple setup process, and therefore may not require extensive custom system design and programming to interface with multiple different testing systems. Accordingly, some implementations described herein may provide improved reporting and management of validation testing of computer systems.

Note that, while FIGS. 1-8 show various examples, implementations are not limited in this regard. For example, referring to FIG. 1, it is contemplated that the system 100 may include additional devices and/or components, fewer components, different components, different arrangements, and so forth. In another example, it is contemplated that the functionality of the test report device 110 described above may be included in another device or component, in a combination of devices, in a remote service, and so forth. Other combinations and/or variations are also possible.

Data and instructions are stored in respective storage devices, which are implemented as one or multiple computer-readable or machine-readable storage media. The storage media include different forms of non-transitory memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other types of storage devices.

Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

What is claimed is:

1. A computing device comprising:
a controller;
a memory; and
a machine-readable storage storing instructions, the instructions executable by the controller to:
receive a plurality of validation test updates from a plurality of test systems, wherein each validation test update comprises test data and a line item label, and wherein the test data indicates a progress level of a validation test of a computing system;
generate a plurality of validation test records in a database based on the received plurality of validation test updates;
determine a set of line item labels to be included in a test summary report;
identify a set of validation test records in the database that match the determined set of line item labels; and
generate the test summary report based on the identified set of validation test records that match the set of line item labels.

2. The computing device of claim 1, wherein each validation test update further comprises a system under test identifier, wherein the test summary report comprises a plurality of report line items, and wherein each report line item is associated with a different combination of one line item label and one system under test identifier.

3. The computing device of claim 1, including instructions executable by the controller to:
receive a report definition specifying the set of line item labels;
store the report definition in the database;
receive a request to generate the test summary report, wherein the stored report definition is associated with the requested test summary report; and
in response to a receipt of the request, read the stored report definition to determine the set of line item labels to be included in the requested test summary report.

4. The computing device of claim 1, including instructions executable by the controller to:
for each validation test update of the received plurality of validation test updates:
compare the line item label included in the validation test update to a plurality of line item labels stored in the database; and
in response to a determination that the line item label included in the validation test update matches one of the plurality of line item labels stored in the database, generate a new validation test record in the database based on the validation test update.

5. The computing device of claim 1, including instructions executable by the controller to:
receive an annotation associated with a first validation test update of the received plurality of validation test updates;
append the annotation to a first validation test record associated with the first validation test update, wherein the first validation test update is included in the identified set of validation test records that match the set of line item labels; and
include the annotation in a first line item of the generated test summary report, wherein the first line item includes information from the first validation test update.

6. The computing device of claim 5, wherein the information from the first validation test update comprises a test pass percentage, a test completed percentage, a test start time, and a last update time.

7. The computing device of claim 1, wherein the plurality of validation test updates are received via a push interface from the plurality of test systems.

8. The computing device of claim 1, wherein the plurality of test systems comprises a plurality of different test software applications.

9. A method comprising:
receiving, by a test report device, a plurality of validation test updates from a plurality of test systems, wherein each validation test update comprises test data and a line item label, and wherein the test data indicates a progress level of a validation test of a computing system;
generating, by the test report device, a plurality of validation test records in a database based on the received plurality of validation test updates;
determining, by the test report device, a set of line item labels to be included in a test summary report;
identifying, by the test report device, a set of validation test records in the database that match the determined set of line item labels; and
generating, by the test report device, the test summary report based on the identified set of validation test records that match the set of line item labels.

10. The method of claim 9, wherein each validation test update further comprises a system under test identifier, wherein the test summary report comprises a plurality of report line items, and wherein each report line item is associated with a different combination of one line item label and one system under test identifier.

11. The method of claim 10, further comprising:
receiving a new line item label for generation of test summary reports;
storing the new line item label in the database; and
configuring the plurality of test systems to send each validation test update including the new line item label and the system under test identifier.

12. The method of claim 9, further comprising:
receiving a report definition specifying the set of line item labels;
storing the report definition in the database;
receiving a request to generate the test summary report, wherein the stored report definition is associated with the requested test summary report; and
in response to a receipt of the request, reading the stored report definition to determine the set of line item labels to be included in the requested test summary report.

13. The method of claim 9, further comprising:
for each validation test update of the received plurality of validation test updates:
comparing the line item label included in the validation test update to a plurality of line item labels stored in the database; and
in response to a determination that the line item label included in the validation test update matches one of the plurality of line item labels stored in the database, generate a new validation test record in the database based on the validation test update.

14. The method of claim 9, further comprising:
receiving an annotation associated with a first validation test update of the received plurality of validation test updates;
appending the annotation to a first validation test record associated with the first validation test update, wherein the first validation test update is included in the identified set of validation test records that match the set of line item labels; and
including the annotation in a first line item of the generated test summary report, wherein the first line item includes information from the first validation test update.

15. The method of claim 9, further comprising:
receiving the plurality of validation test updates via a push interface from the plurality of test systems.

16. A non-transitory machine-readable medium storing instructions that upon execution cause a processor to:
receive a plurality of validation test updates from a plurality of test systems, wherein each validation test update comprises test data and a line item label, and wherein the test data indicates a progress level of a validation test of a computing system;
generate a plurality of validation test records in a database based on the received plurality of validation test updates;
determine a set of line item labels to be included in a test summary report;
identify a set of validation test records in the database that match the determined set of line item labels; and
generate the test summary report based on the identified set of validation test records that match the set of line item labels.

17. The non-transitory machine-readable medium of claim 16, wherein each validation test update further comprises a system under test identifier, wherein the test summary report comprises a plurality of report line items, and wherein each report line item is associated with a different combination of one line item label and one system under test identifier.

18. The non-transitory machine-readable medium of claim 16, including instructions that upon execution cause the processor to:
receive a report definition specifying the set of line item labels;
store the report definition in the database;
receive a request to generate the test summary report, wherein the stored report definition is associated with the requested test summary report; and
in response to a receipt of the request, read the stored report definition to determine the set of line item labels to be included in the requested test summary report.

19. The non-transitory machine-readable medium of claim 16, including instructions that upon execution cause the processor to:
for each validation test update of the received plurality of validation test updates:
compare the line item label included in the validation test update to a plurality of line item labels stored in the database; and
in response to a determination that the line item label included in the validation test update matches one of the plurality of line item labels stored in the database, generate a new validation test record in the database based on the validation test update.

20. The non-transitory machine-readable medium of claim 16, including instructions that upon execution cause the processor to:
receive an annotation associated with a first validation test update of the received plurality of validation test updates;
append the annotation to a first validation test record associated with the first validation test update, wherein the first validation test update is included in the identified set of validation test records that match the set of line item labels; and
include the annotation in a first line item of the generated test summary report, wherein the first line item includes information from the first validation test update.
